(19) United States
(12) Patent Application Publication
(10) Pub. No.: US 2026/0018343 A1
(43) Pub. Date: Jan. 15, 2026

(54) CERAMIC ELECTRONIC COMPONENT AND MANUFACTURING METHOD OF THE SAME

(71) Applicant: TAIYO YUDEN CO., LTD., Tokyo (JP)

(72) Inventor: Ayumi SHIROTA, Takasaki-shi (JP)

(21) Appl. No.: 19/332,536

(22) Filed: Sep. 18, 2025

Related U.S. Application Data
(63) Continuation of application No. PCT/JP2024/012713, filed on Mar. 28, 2024.

(30) Foreign Application Priority Data
Mar. 30, 2023 (JP) 2023-055562

(51) Int. Cl. H01G 4/30; H01G 4/008; H01G 4/232

(52) U.S. Cl. CPC H01G 4/30; H01G 4/0085; H01G 4/2325

(57) ABSTRACT

The first internal electrode layer contains a low-melting point metal having a melting point lower than the melting point of Pb. The concentration of the low-melting point metal is higher in the first internal electrode layer than in the second internal electrode layer. The width in a direction orthogonal to the stacking direction of a portion of the first internal electrode layer connecting to the first external electrode is narrower than the width of a portion facing the second internal electrode layer. The width in a direction orthogonal to the stacking direction of a portion of the second internal electrode layer connecting to the second external electrode is wider than the width of a portion of the first internal electrode layer connecting to the first external electrode.

### CROSS-REFERENCE TO RELATED APPLICATION

This application is a continuation application of PCT/JP2024/012713 filed on Mar. 28, 2024, which claims priority to Japanese Patent Application No. 2023-055562 filed on Mar. 30, 2023, the contents of which are herein wholly incorporated by reference.

### FIELD

A certain aspect of the present disclosure relates to a ceramic electronic component and a manufacturing method of the same.

### BACKGROUND

In recent years, the spread of electric vehicles has created a demand for improved reliability in electronic components they are mounted on, such as in terms of mechanical strength or moisture resistance. In addition, while the mounting area of the ceramic electronic components on a circuit board is being limited in order to achieve even higher functionality, there is a demand for the ceramic electronic components to be stacked in even greater numbers.

### SUMMARY OF THE INVENTION

A ceramic electronic component of the present invention includes: a multilayer chip in which a first internal electrode layer mainly made of Ni and a second internal electrode layer mainly made of Ni are alternately stacked with a dielectric layer sandwiched therebetween, has a substantially rectangular parallelepiped shape, and is formed so that the first internal electrode layer and the second internal electrode layer are alternately drawn out to first and second end faces opposing each other of the substantially rectangular parallelepiped shape; a first external electrode provided on the first end face, the first external electrode having a contact layer in contact with the first end face, the contact layer being mainly composed of Cu; and a second external electrode provided on the second end face, the second external electrode having a contact layer that is in contact with the second end face and that is mainly composed of Cu, wherein at least the first internal electrode layer of the first internal electrode layer and the second internal electrode layer contains a low melting point metal having a melting point lower than a melting point of Pb, wherein a concentration of the low melting point metal is higher in the first internal electrode layer than in the second internal electrode layer, wherein a width of a portion of the first internal electrode layer that connects to the first external electrode in a direction orthogonal to a stacking direction is narrower than a width of a portion facing the second internal electrode layer, and wherein a width of a portion of the second internal electrode layer that connects to the second external electrode in a direction orthogonal to the stacking direction is wider than a width of a portion of the first internal electrode layer that connects to the first external electrode.

A manufacturing method of a ceramic electronic component of the present invention includes: preparing a multilayer chip in which a first internal electrode layer mainly made of Ni and a second internal electrode layer mainly made of Ni are alternately stacked with a dielectric layer sandwiched therebetween, has a substantially rectangular parallelepiped shape, and is formed so that the first internal electrode layer and the second internal electrode layer are alternately drawn out to first and second end faces opposing each other of the substantially rectangular parallelepiped shape, wherein at least the first internal electrode layer of the first internal electrode layer and the second internal electrode layer contains a low melting point metal having a melting point lower than a melting point of Pb, wherein a concentration of the low melting point metal is higher in the first internal electrode layer than in the second internal electrode layer, wherein a width of a portion of the first internal electrode layer drawn to the first end face in a direction orthogonal to a stacking direction is narrower than a width of a portion facing the second internal electrode layer, and wherein a width of a portion of the second internal electrode layer drawn to the second end face in a direction orthogonal to the stacking direction is wider than a width of a portion of the first internal electrode layer drawn to the first end face; and baking an external electrode on each of the first end face and the second end face, a main component of the external electrode being Cu.

### BRIEF DESCRIPTION OF THE DRAWINGS

FIG. 1 is a partial cross-sectional perspective view of a multilayer ceramic capacitor according to a first embodiment;

FIG. 2 is a cross-sectional view taken along line A-A in FIG. 1;

FIG. 3 is a cross-sectional view taken along line B-B in FIG. 1;

FIG. 4A is an enlarged cross-sectional view of vicinity of a first external electrode, and

FIG. 4B is an enlarged cross-sectional view of vicinity of a second external electrode;

FIG. 5 is a diagram illustrating a crack;

FIG. 6A is a plan view of a first internal electrode layer, and FIG. 6B is a plan view of a second internal electrode layer;

FIG. 7 is a diagram illustrating a wraparound length of an external electrode;

FIG. 8 is a diagram illustrating a flow of a method for manufacturing a multilayer ceramic capacitor;

FIG. 9 is a diagram illustrating a stacking process;

FIG. 10A is a plan view of a first internal electrode layer, and FIG. 10B is a plan view of a third internal electrode layer;

FIG. 11 is a diagram illustrating a first end face of a multilayer chip;

FIG. 12 is a diagram illustrating a stacking process;

FIG. 13 is an external view of a multilayer ceramic capacitor according to a third embodiment;

FIG. 14A and FIG. 14B are partial cross-sectional perspective views of a multilayer ceramic capacitor according to a third embodiment;

FIG. 15 is a view illustrating a first internal electrode layer;

FIG. 16 is a view illustrating a stacking process;

FIG. 17A and FIG. 17B are partial cross-sectional perspective views of a multilayer ceramic capacitor according to a fourth embodiment;

FIG. 18 is a view illustrating shapes of a first internal electrode layer, a second internal electrode layer, and a third internal electrode layer;

FIG. 19 is a stacking process;

FIG. 20 is a side view of a circuit board including a multilayer ceramic capacitor;

FIG. 21 is a view illustrating a package; and

FIG. 22 is a view illustrating a package.

### DETAILED DESCRIPTION

In order to improve the mechanical strength of the ceramic electronic components, it has been proposed to solid-dissolve tin in only one of the internal electrodes containing nickel, thereby changing the stress distribution inside the ceramic electronic component and improving the flexural strength (see, for example, Japanese Patent Application Publication No. 2018-198292).

On the other hand, there is a problem that when the external electrode is baked, the internal electrode and the external electrode react, and the copper, which is the metal component of the external electrode, diffuses to the nickel side of the internal electrode, causing the internal electrode to expand, generating outward stress in the cover and side margins, which cannot withstand the stress and cause cracks (see, for example, Japanese Patent Application Publication No. 2014-175034).

In particular, when an internal electrode containing a low-melting point metal such as tin (melting point is 231.97° C.) is used, the diffusion of the external electrode components to the internal electrode side is promoted when the external electrode is baked, and the occurrence of the above-mentioned cracks becomes a major problem.

Hereinafter, an exemplary embodiment will be described with reference to the accompanying drawings.

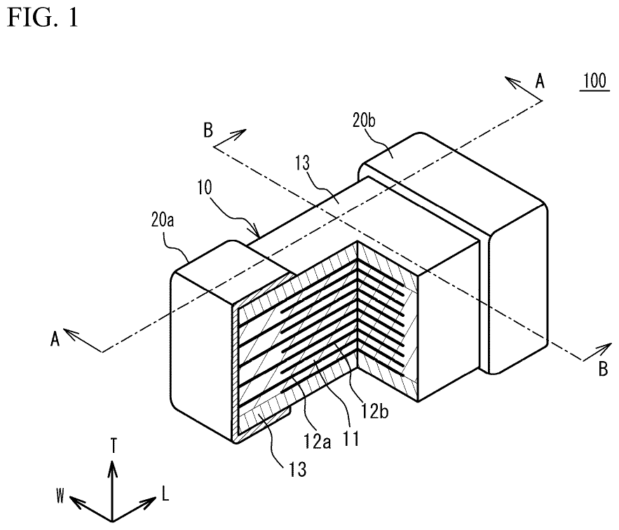

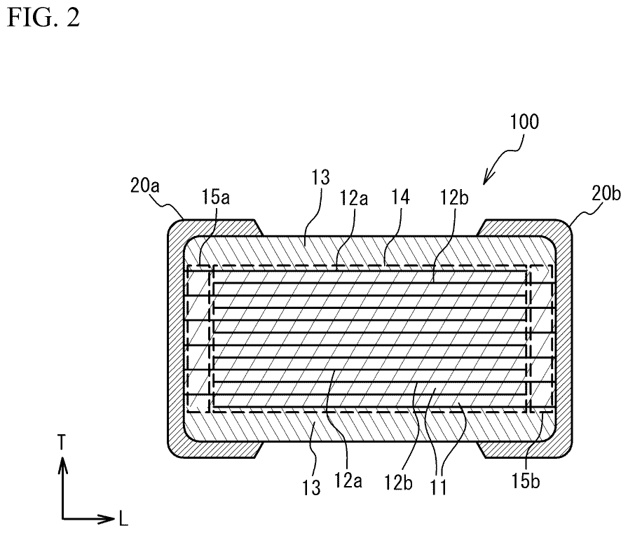

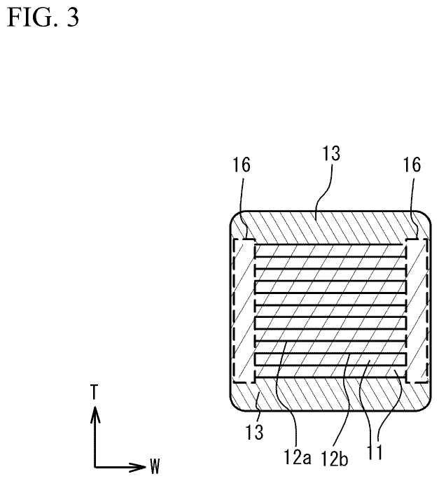

(First Embodiment) FIG. 1 illustrates a perspective view of a multilayer ceramic capacitor 100, in which a cross section of a part of the multilayer ceramic capacitor 100 is illustrated. FIG. 2 is a cross-sectional view taken along line A-A in FIG. 1. FIG. 3 is a cross-sectional view taken along line B-B in FIG. 1. As illustrated in FIG. 1 to FIG. 3, the multilayer ceramic capacitor 100 includes a multilayer chip 10 having a rectangular parallelepiped shape. A first external electrode 20a and a second external electrode 20b are provided on two opposing end faces (a first end face and a second end face) of the multilayer chip 10, respectively. Among four faces other than the two end faces of the multilayer chip 10, two faces other than the upper face and the lower face in the stacking direction are referred to as side faces. The first external electrode 20a extends from the first end face to the four adjacent faces. The second external electrode 20b extends from the second end face to the four adjacent faces. However, the first external electrode 20a and the second external electrode 20b are spaced apart from each other.

In FIG. 1 to FIG. 3, the L direction is the length direction of the multilayer chip 10, the direction in which the two end faces of the multilayer chip 10 face each other, and the direction in which the first external electrode 20a and the second external electrode 20b face each other. The W direction is the width direction of the internal electrode layers, and the direction in which the two side faces other than the two end faces of the multilayer chip 10 face each other. The T direction is the stacking direction, and the direction in which the upper and lower faces of the multilayer chip 10 face each other. The L direction, the W direction, and the T direction are orthogonal to each other.

The multilayer chip 10 has a structure designed to have dielectric layers 11 containing a ceramic material acting as a dielectric material and internal electrode layers alternately stacked. The internal electrode layers include a plurality of first internal electrode layers 12a and a plurality of second internal electrode layers 12b. The first internal electrode layers 12a and the second internal electrode layers 12b are alternately stacked. The edge of the first internal electrode layer 12a is drawn to the first end face of the multilayer chip 10 on which the first external electrode 20a is provided. The edge of the second internal electrode layer 12b is drawn to the second end face of the multilayer chip 10 on which the second external electrode 20b is provided. As a result, the first internal electrode layer 12a and the second internal electrode layer 12b are alternately conductive to the first external electrode 20a and the second external electrode 20b. As a result, the multilayer ceramic capacitor 100 has a configuration in which capacitor units are stacked. In the multilayer body of the dielectric layers 11 and the internal electrode layers, the internal electrode layers are disposed as the outermost layers in the stacking direction, and the upper and lower faces of the multilayer body are covered with cover layers 13.

The cover layers 13 are mainly composed of a ceramic material. For example, the cover layers 13 may have the same composition as the dielectric layers 11 or may have a different composition.

For example, the multilayer ceramic capacitor 100 may have a length of 0.25 mm, a width of 0.125 mm and a height of 0.125 mm, or a length of 0.4 mm, a width of 0.2 mm and a height of 0.2 mm, or a length of 0.6 mm, a width of 0.3 mm and a height of 0.3 mm, or a length of 1.0 mm, a width of 0.5 mm and a height of 0.5 mm, or a length of 3.2 mm, a width of 1.6 mm and a height of 1.6 mm, or a length of 4.5 mm, a width of 3.2 mm, and a height of 2.5 mm. However, the size is not limited to the above sizes.

A main component of the dielectric layer 11 is a ceramic material having a perovskite structure expressed by a general formula ABO₃. The perovskite structure includes ABO_{3-α} having an off-stoichiometric composition. For example, the ceramic material is such as BaTiO₃ (barium titanate), CaZrO₃ (calcium zirconate), CaTiO₃ (calcium titanate), SrTiO₃ (strontium titanate), MgTiO₃ (magnesium titanate), Ba_{1-x-y}CaₓSr_{y}Ti_{1-z}Zr_{z}O₃ (0≤x≤1, 0≤y≤1, 0≤z≤1) having a perovskite structure. Ba_{1-x-y}CaₓSr_{y}Ti_{1-z}Zr_{z}O₃ may be barium strontium titanate, barium calcium titanate, barium zirconate, barium titanate zirconate, calcium titanate zirconate, barium calcium titanate zirconate or the like. The thickness of the dielectric layer 11 is, for example, not less than 0.3 μm and not more than 3 μm.

A main component of the cover layer 13 is a ceramic material having a perovskite structure expressed by a general formula ABO₃. The perovskite structure includes ABO_{3-α} having an off-stoichiometric composition. For example, the ceramic material is such as BaTiO₃ (barium titanate), CaZrO₃ (calcium zirconate), CaTiO₃ (calcium titanate), SrTiO₃ (strontium titanate), MgTiO₃ (magnesium titanate), Ba_{1-x-y}CaₓSr_{y}Ti_{1-z}Zr_{z}O₃ (0≤x≤1, 0≤y≤1, 0≤z≤1) having a perovskite structure. Ba_{1-x-y}CaₓSr_{y}Ti_{1-z}Zr_{z}O₃ may be barium strontium titanate, barium calcium titanate, barium zirconate, barium titanate zirconate, calcium titanate zirconate, barium calcium titanate zirconate or the like. The main component of the cover layer 13 may be the same as that of the dielectric layer or may be different from that of the dielectric layer 11.

Additives may be added to the dielectric layer 11 and the cover layer 13. As additives to the dielectric layer 11 and the cover layer 13, magnesium (Mg), manganese (Mn), molybdenum (Mo), vanadium (V), chromium (Cr), rare earth elements (yttrium (Y), samarium (Sm), europium (Eu), gadolinium (Gd), terbium (Tb), dysprosium (Dy), holmium (Ho), erbium (Er), thulium (Tm), and ytterbium (Yb)) or an oxide of cobalt (Co), nickel (Ni), lithium (Li), boron (B), sodium (Na), potassium (K) or silicon (Si), or a glass including cobalt, nickel, lithium, boron, sodium, potassium or silicon.

The first internal electrode layer 12a and the second internal electrode layer 12b are mainly composed of Ni. For example, the first internal electrode layer 12a and the second internal electrode layer 12b contain 85 at % or more of Ni. The first internal electrode layer 12a and the second internal electrode layer 12b may contain ceramic grains or the like as a co-material. The thickness of the first internal electrode layer 12a and the second internal electrode layer 12b is, for example, 0.1 μm or more and 2 μm or less.

As illustrated in FIG. 2, the section where the first internal electrode layers 12a connected to the first external electrode 20a faces the second internal electrode layers 12b connected to the second external electrode 20b is a section where electric capacity is generated in the multilayer ceramic capacitor 100. Thus, this section generating the electric capacity is referred to as a capacity section 14. That is, the capacity section 14 is a section where two adjacent internal electrode layers connected to different external electrodes face each other. The section where the first internal electrode layers 12a connected to the first external electrode 20a face each other without the second internal electrode layers 12b connected to the second external electrode 20b interposed therebetween is referred to as a first end margin 15a. The section where the second internal electrode layers 12b connected to the second external electrode 20b face each other without the first internal electrode layers 12a connected to the first external electrode 20a interposed therebetween is a second end margin 15b. That is, the end margin is a section where the internal electrode layers connected to one of the external electrodes face each other with no internal electrode layer connected to the other of the external electrodes interposed therebetween. The first end margin 15a and the second end margin 15b are sections where no electric capacity is generated.

As illustrated in FIG. 3, in the multilayer chip 10, a side margin 16 is a section provided so as to cover the ends (ends in the W direction) of the two side faces of the dielectric layers 11, the first internal electrode layers 12a and the second internal electrode layers 12b. That is, the side margin 16 is a section provided outside the capacity section 14 in the W direction. The side margin 16 is also a section where no electric capacity is generated.

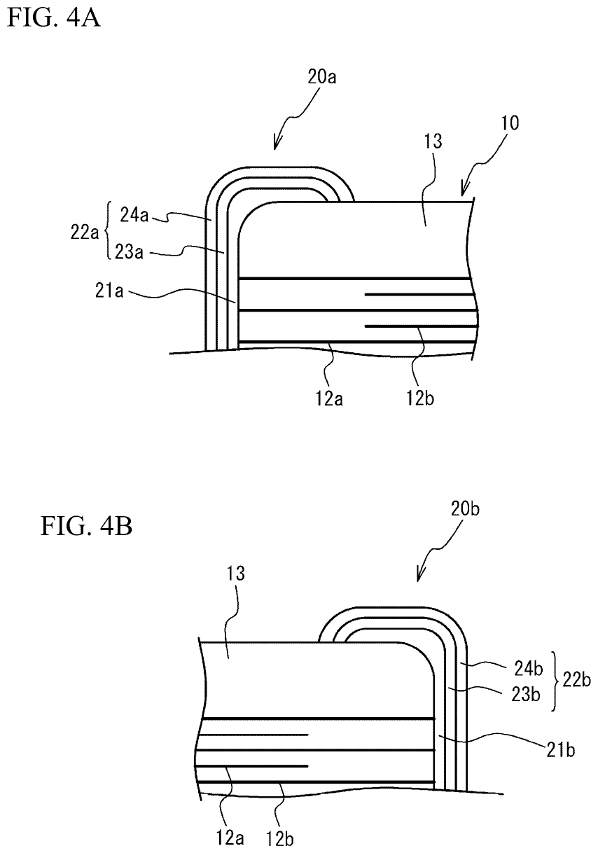

FIG. 4A is an enlarged cross-sectional view of the first external electrode 20a and its vicinity. Hatching is omitted in FIG. 4A. As illustrated in FIG. 4A, the first external electrode 20a has a structure in which a plated layer 22a is provided on a base layer 21a. The base layer 21a functions as a contact layer that contacts the first end face of the multilayer chip 10. The base layer 21a is mainly composed of copper (Cu). The base layer 21a may also contain a glass component. The base layer 21a contains 80 at % or more of Cu.

The plated layer 22a is mainly composed of a metal such as Ni, Cu, Al (aluminum), Zn (zinc), or tin (Sn), or an alloy of two or more of these metals. The plated layer 22a may be a plated layer of a single metal component, or may be a plated layer of multiple plated layers of different metal components. For example, in FIG. 4A, the plated layer 22a has a structure in which a first plated layer 23a and a second plated layer 24a are formed in this order from the base layer 21a side. The first plated layer 23a is, for example, a Ni-plated layer. The second plated layer 24a is, for example, an Sn-plated layer.

FIG. 4B is an enlarged cross-sectional view of the vicinity of the second external electrode 20b. Hatching is omitted in FIG. 4B. As illustrated in FIG. 4B, the second external electrode 20b has a structure in which a plated layer 22b is provided on a base layer 21b. The base layer 21b functions as a contact layer that contacts the second end face of the multilayer chip 10. The base layer 21b is mainly composed of Cu. The base layer 21b may also contain a glass component. The base layer 21a contains 80 at % or more of Cu.

The plated layer 22b is mainly composed of a metal such as Ni, Cu, Al, Zn, Sn, or an alloy of two or more of these metals. The plated layer 22b may be a plated layer of a single metal component, or may be a plurality of plated layers of different metal components. For example, the plated layer 22b has a structure in which, from the base layer 21b side, a first plated layer 23b and a second plated layer 24b are formed. The first plated layer 23b is, for example, a Ni-plated layer. The second plated layer 24b is, for example, an Sn-plated layer.

The base layer 21a and the base layer 21b may have the same composition, or may have different compositions. The plated layer 22a and the plated layer 22b may have the same layered structure, or may have different layered structures. For example, the number of layers of the plated layers may be different. The first plated layer 23a and the first plated layer 23b may have the same composition, or may have different compositions. The second plated layer 24a and the second plated layer 24b may have the same composition, or may have different compositions.

The first internal electrode layer 12a contains a low melting point metal in addition to the main component Ni. The low melting point metal is a metal that has a melting point lower than the melting point of lead (Pb (melting point: 327.5° C.)). For example, bismuth (Bi (melting point: 271.4° C.)), Sn (melting point: 231.97° C.), indium (In (melting point: 156.61° C.)) or the like is included. The second internal electrode layer 12b does not include the low melting point metal. The second internal electrode layer 12b may include the low melting point metal, but the concentration of the low melting point metal is lower in the second internal electrode layer 12b than in the first internal electrode layer 12a.

This configuration can cause a change in the stress distribution inside the multilayer ceramic capacitor 100, improving mechanical strength such as flexural strength. For example, in the first internal electrode layer 12a, when the main component Ni is 100 at %, the low melting point metal is included at 0.5 at % or more and 3 at % or less, 0.7 at % or more and 2 at % or less, or 1 at % or more and 1.5 at % or less. In the second internal electrode layer 12b, when the main component Ni is 100 at %, the low melting point metal is 0.5 at % or less, 0.3 at % or less, and 0.1 at % or less.

When multiple types of low melting point metals are included, the concentration of the low melting point metal means the at % of the total amount of all the low melting point metals when Ni is 100 at %.

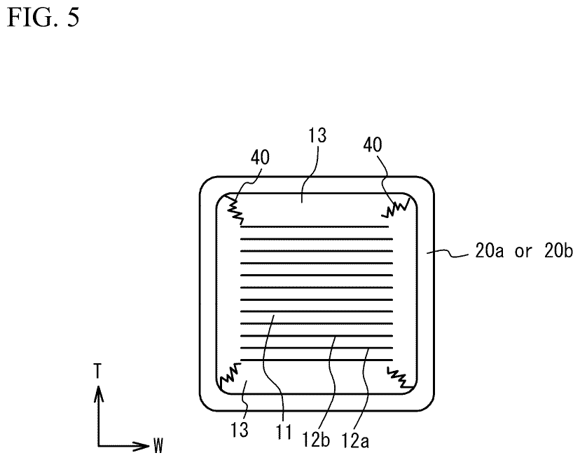

In the multilayer ceramic capacitor 100, when the first external electrode 20a and the second external electrode 20b are baked, a crack 40 as illustrated in FIG. 5 may occur in the portion covered by the external electrodes where the cover layer and the side margin overlap (the corner portion near the external electrodes).

This occurs based on the following mechanism. When the internal electrode layer reacts with the base layers 21a, 21b during firing of the base layers 21a, 21b, Cu, which is a metal component of the base layers 21a, 21b, diffuses to the Ni side of the internal electrode layer, causing the internal electrode layer to expand. This expansion of the internal electrode layer generates outward stress in the cover layer 13 and the side margin 16, causing cracks. In particular, if the internal electrode layer contains the low melting point metal, the diffusion of the external electrode component to the internal electrode side is promoted during firing of the external electrode, and the occurrence of the cracks 40 becomes a major problem.

The multilayer ceramic capacitor 100 according to this embodiment has a configuration that can suppress the occurrence of the cracks 40. Details are described below.

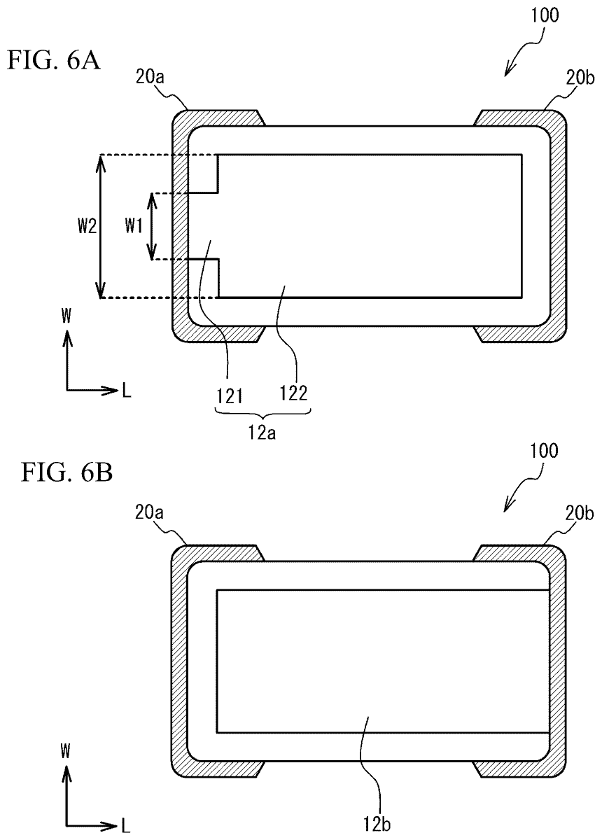

FIG. 6A is a plan view of the first internal electrode layer 12a. As illustrated in FIG. 6A, the first internal electrode layer 12a has a first section 121 (drawing portion) connected to the first external electrode 20a in a section corresponding to the first end margin 15a and having a width W1, and a second section 122 having a width W2 in a section corresponding to the capacity section 14. The second section 122 is a section facing the second internal electrode layer 12b. The width W1 is smaller than the width W2. The widths W1 and W2 refer to the widths in the W direction, that is, the widths in the direction orthogonal to the stacking direction. With this configuration, the diffusion path of Cu when the first external electrode 20a is baked is narrowed. As a result, even if the first internal electrode layer 12a contains the low melting point metal, the diffusion of Cu is suppressed. As a result, the occurrence of the cracks 40 is suppressed.

The first section 121 may have a shape in which the width becomes narrower as the first section approaches the first external electrode 20a. In this case, the width W1 is the width of the portion where the first section 121 is connected to the first external electrode 20a.

FIG. 6B is a plan view of the second internal electrode layer 12b. As illustrated in FIG. 6B, the width in the W direction of the portion of the second internal electrode layer 12b that is connected to the second external electrode 20b is wider than the width in the W direction of the first section 121. For example, the width in the W direction of the second internal electrode layer 12b is approximately constant at any point in the L direction. For example, the width in the W direction of the portion where the second internal electrode layer 12b is connected to the second external electrode 20b is approximately equal to W2. This configuration improves the contact between the second internal electrode layer 12b and the second external electrode 20b, ensuring the electrostatic capacity of the multilayer ceramic capacitor 100.

For example, if W1/W2 is small, there is a risk of a decrease in capacity due to poor contact between the first external electrode 20a and the first internal electrode layer 12a. Therefore, it is preferable to set a lower limit for W1/W2. In this embodiment, when W2 is 100%, W1 is preferably 60% or more, and more preferably 70% or more. On the other hand, from the viewpoint of suppressing the cracks 40 due to expansion of the first internal electrode layer 12a, W1 is preferably 90% or less, and more preferably 80% or less.

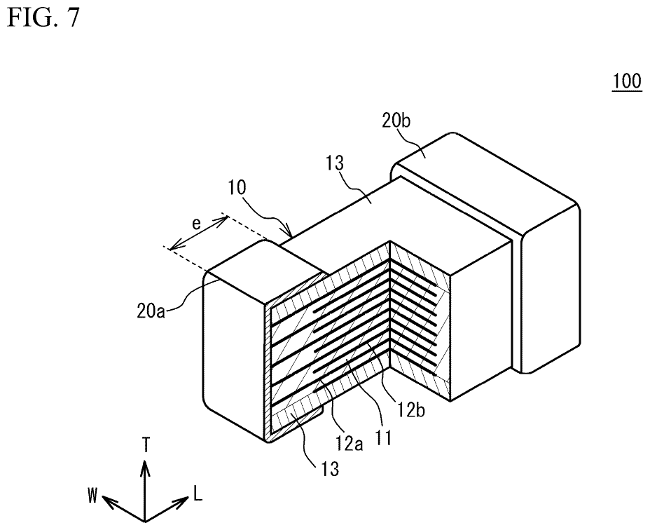

Furthermore, from the viewpoint of suppressing the cracks 40 due to expansion of the first internal electrode layer 12a, the length in the L direction of the first section 121 is preferably ¼ or more, and more preferably ½ or more of the wraparound length in the L direction of the first external electrode 20a (dimension e in FIG. 7). On the other hand, from the viewpoint of ensuring the intersection area between the first internal electrode layer 12a and the second internal electrode layer 12b, the length in the L direction of the first section 121 is preferably 1/1 or less of the dimension e, and more preferably ¾ or less.

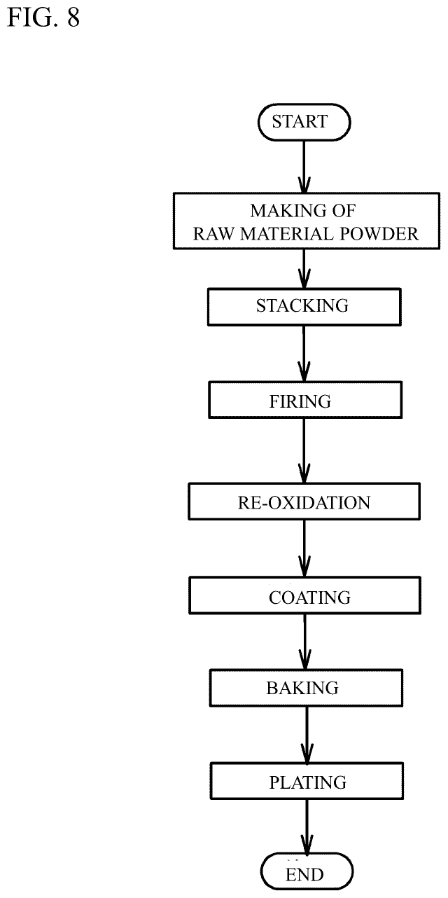

Next, a description will be given of a manufacturing method of the multilayer ceramic capacitors 100. FIG. 8 illustrates a flow of the manufacturing method of the multilayer ceramic capacitor 100.

(Making process of raw material powder) A dielectric material for forming the dielectric layer 11 is prepared. An A site element and a B site element are included in the dielectric layer 11 in a sintered phase of grains of ABO₃. For example, BaTiO₃ is tetragonal compound having a perovskite structure and has a high dielectric constant. Generally, BaTiO₃ is obtained by reacting a titanium material such as titanium dioxide with a barium material such as barium carbonate and synthesizing barium titanate. Various methods have been conventionally known for synthesizing the main component ceramic of the dielectric layer 11, such as a solid phase method, a sol-gel method, a hydrothermal method, etc. Any of these methods can be used in this embodiment.

A specific additive compound is added to the obtained ceramic powder according to the purpose. An example of additive compound is such as an oxide of Mg, Mn, Mo, V, Cr, a rare earth element (Y, Sm, Eu, Gd, Tb, Dy, Ho, Er, Tm or Yb), an oxide containing Co, Ni, Li, B, Na, K or Si, or a glass containing Co, Ni, Li, B, Na, K or Si. Of these, SiO₂ mainly functions as a sintering aid.

For example, a ceramic material is prepared by wet-mixing a compound containing an additive compound with a ceramic raw material powder, drying and pulverizing the mixture. For example, the ceramic material obtained as described above may be pulverized to adjust the particle size, if necessary, or may be combined with a classification process to adjust the particle size. Through the above steps, a dielectric material is obtained.

(Stacking process) Next, a binder such as polyvinyl butyral (PVB) resin, an organic solvent such as ethanol or toluene, and a plasticizer are added to the obtained raw material powder and wet mixed. The obtained slurry is used to coat a dielectric green sheet 51 on a base material by, for example, a die coater method or a doctor blade method, and then dried. The base material is, for example, a polyethylene terephthalate (PET) film.

Next, an internal electrode pattern 52a is formed on the dielectric green sheet 51 to form a first stack unit. The internal electrode pattern 52a corresponds to the shape of the first internal electrode layer 12a. The width of the internal electrode pattern 52a is approximately equal to the width of the dielectric green sheet 51. A metal paste containing the metal component of the first internal electrode layer 12a is used for the internal electrode pattern 52a. The film formation method may be printing, sputtering, vapor deposition, or the like. Furthermore, an internal electrode pattern 52 is formed on the dielectric green sheet 51 to form a second stack unit. The internal electrode pattern 52 corresponds to the shape of the second internal electrode layer 12b. The width of the internal electrode pattern 52 is approximately equal to the width of the dielectric green sheet 51. A metal paste containing the metal component of the second internal electrode layer 12b is used for the internal electrode pattern 52. The film formation method may be printing, sputtering, vapor deposition, or the like.

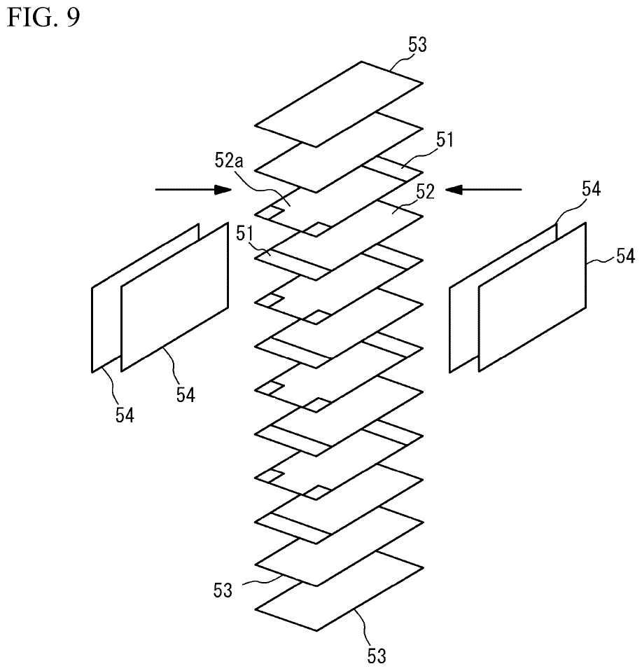

Next, while peeling the dielectric green sheet 51 from the substrate, the first and second stack units are alternately stacked as illustrated in FIG. 9. Next, a predetermined number of cover sheets 53 (for example, 2 to 10 layers) are stacked on top and bottom of the stack obtained by stacking the first and second stack units, and are thermocompression bonded. The cover sheets 53 can be formed by the same method as the dielectric green sheet 51. Next, multiple side margin sheets 54 are attached to each of both side surfaces of the stack. The side margin sheets 54 can be formed by the same method as the dielectric green sheet 51.

(Firing process) Then, firing is performed at 1100 to 1300° C. for 10 minutes to 2 hours in a reducing atmosphere with an oxygen partial pressure of 10-5 to 10-8 atm.

(Re-oxidation process) Then, reoxidation may be performed at 600° C. to 1000° C. in an N₂ gas atmosphere.

(Coating process) Next, a metal paste that will become the base layers 21a and 21b is coated on the first side of the stack by a dipping method or the like. This metal paste contains a glass component such as glass frit.

(Baking process) Then, the metal paste is baked at a temperature of about 700° C. to 900° C. to form the base layers 21a and 21b.

(Plating process) After that, a metal coating such as Cu, Ni, Sn, and so on may be applied to the base layers 21a and 21b by plating. For example, a first plated layer and a second plated layer are formed in this order on the base layers 21a and 21b. This completes the multilayer ceramic capacitor 100.

According to the manufacturing method of this embodiment, the diffusion path of Cu when the first external electrode 20a is baked is narrowed. As a result, even if the first internal electrode layer 12a contains the low melting point metal, the diffusion of Cu is suppressed. As a result, the occurrence of the cracks 40 is suppressed. On the other hand, the width in the W direction of the portion of the second internal electrode layer 12b that connects to the second external electrode 20b is wider than the width in the W direction of the first section 121. As a result, the contact between the second internal electrode layer 12b and the second external electrode 20b is good, and the electrostatic capacity of the multilayer ceramic capacitor 100 is ensured.

(Second embodiment) In the first embodiment, all the internal electrode layers connected to the first external electrode 20a have the first section 121, but some of the internal electrode layers may have the first section 121. The multilayer ceramic capacitor 100a according to the second embodiment has a configuration in which some of all the internal electrode layers connected to the first external electrode 20a have the first section 121.

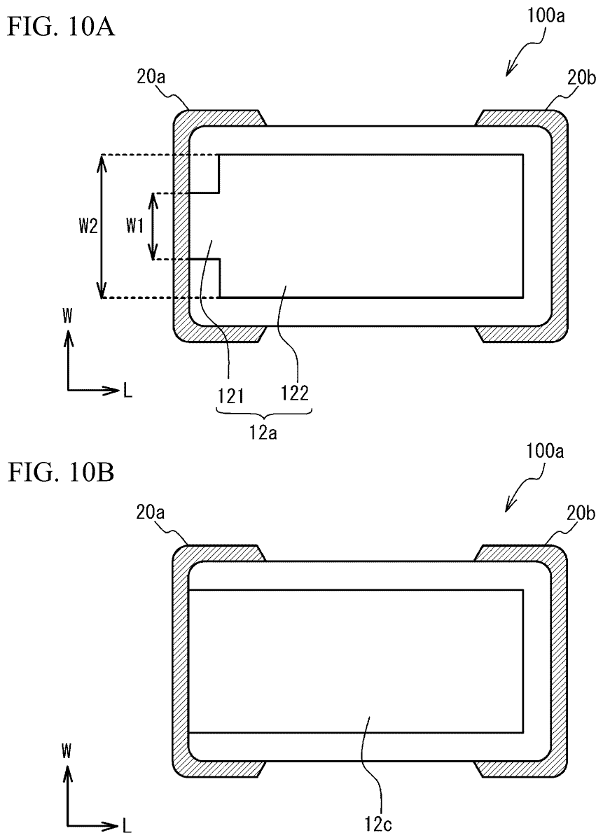

Some of all the internal electrode layers connected to the first external electrode 20a are third internal electrode layers 12c. FIG. 10A is a plan view of the first internal electrode layer 12a. FIG. 10B is a plan view of the third internal electrode layer 12c. As illustrated in FIG. 10B, the width in the W direction of the portion of the third internal electrode layer 12c that connects to the first external electrode 20a is wider than the width in the W direction of the first section 121. For example, the width in the W direction of the third internal electrode layer 12c is approximately constant at any point in the L direction. For example, the width in the W direction of the portion of the third internal electrode layer 12c that connects to the first external electrode 20a is approximately equal to W2. This configuration improves the contact between the third internal electrode layer 12c and the first external electrode 20a, ensuring the electrostatic capacity of the multilayer ceramic capacitor 100.

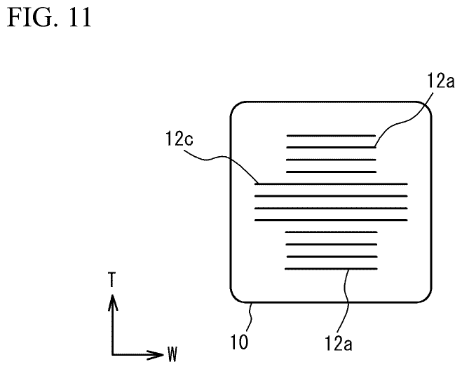

FIG. 11 is a diagram illustrating an example of the first end face of the multilayer chip 10. That is, FIG. 11 is a diagram of the end face of the multilayer chip 10 seen through the first external electrode 20a in a multilayer ceramic capacitor 100a. As illustrated in FIG. 11, one or more of the third internal electrode layers 12c are provided in the center of the stacking direction without the first internal electrode layers 12a. The first internal electrode layers 12a are provided on the outside of the group of the third internal electrode layers 12c in the T direction. With this configuration, the width of the internal electrode layers in the W direction is narrowed in the section close to the cover layer 13. This suppresses diffusion in the corners where the cracks 40 are likely to occur, and thus suppresses the cracks 40. On the other hand, the contact between the internal electrode layers and the first external electrode 20a is good near the center in the stacking direction. As a result, it is possible to suppress the cracks 40 and ensure electrostatic capacity at the same time.

For example, if the number of the third internal electrode layers 12c is small, there is a risk that sufficient electrostatic capacity is not ensured. Therefore, it is preferable to set a lower limit on the number of layers of the third internal electrode layers 12c. On the other hand, if the number of the third internal electrode layers 12c is large, there is a risk that the occurrence of the cracks 40 is not sufficiently suppressed. Therefore, it is preferable to set a lower limit and an upper limit on the number of layers of the third internal electrode layers 12c. In this embodiment, when the total number of internal electrode layers connected to the first external electrode 20a is 100%, it is preferable that the number of layers of the third internal electrode layers 12c is 5% or more and 40% or less.

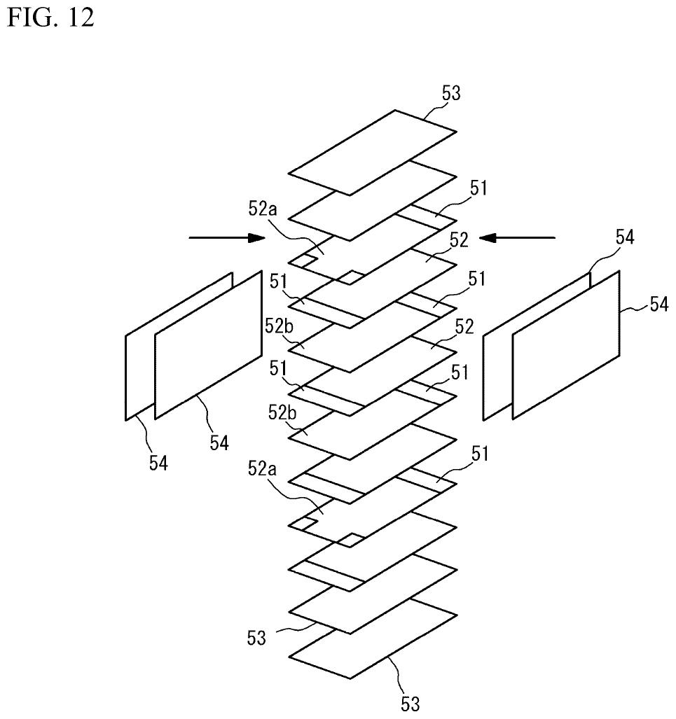

In the multilayer ceramic capacitor 100a according to this embodiment, as illustrated in FIG. 12, for example, when stacking the stack units, a third stack unit in which an internal electrode pattern 52b having the same width as the dielectric green sheet 51 is formed on the dielectric green sheet 51 is used in the center portion instead of a first stack unit in which the internal electrode pattern 52a is formed on the dielectric green sheet 51.

In addition, elements that form stable compounds with hydrogen reduce the effects of hydrogen generated in the plating process and suppress insulation deterioration. Therefore, it is preferable that the second internal electrode layer 12b contains an element that forms a stable compound with hydrogen other than the low melting point metal. Specifically, it is preferable that the second internal electrode layer 12b contains Ni as the main component and contains Ag (silver), Au (gold), Ga (gallium), Ge (germanium), or the like.

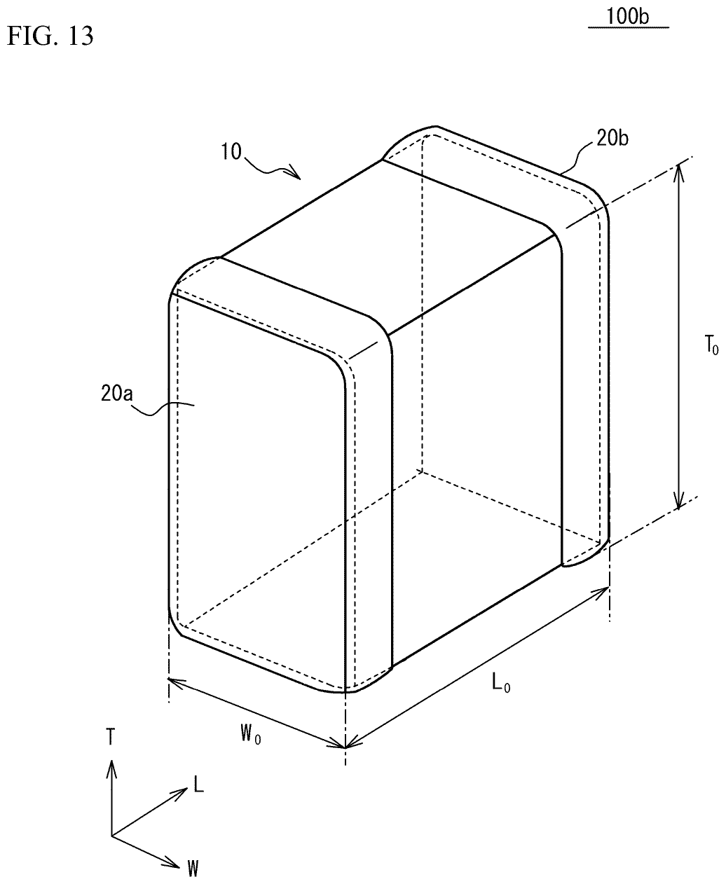

(Third Embodiment) FIG. 13 is an external view of a multilayer ceramic capacitor 100b according to a third embodiment.

The T direction (first direction) is the stacking direction of each layer within the multilayer chip 10, the height direction of the multilayer ceramic capacitor 100b, and the direction in which the upper face and the lower face of the multilayer chip 10 face each other. The W direction (second direction) is the direction in which the two side faces of the multilayer chip 10 face each other. The L direction (third direction) is the direction in which the two end faces of the multilayer chip 10 face each other, and the direction in which the first external electrode 20a and the second external electrode 20b face each other. The L direction, W direction, and T direction are mutually orthogonal. As illustrated in FIG. 13, the height of the multilayer ceramic capacitor 100b in the T direction is defined as height T₀, the width in the W direction is defined as width W₀, and the length in the L direction is defined as length L₀. The height T₀, width W₀, and length L₀ are the maximum dimensions in the T, W, and L directions, respectively.

The multilayer ceramic capacitor 100b according to this embodiment has a shape in which the size in the T direction is larger than the size in the W direction. Specifically, as illustrated in FIG. 13, the multilayer ceramic capacitor 100b has a relationship of T₀≥W₀×1.3. This configuration increases the electrostatic capacity. The height T₀, the width W₀, and the length L₀ are not particularly limited, but, for example, the height T₀ can be set to 0.15 mm or more and 1.0 mm or less, the width W₀ can be set to 0.1 mm or more and 0.7 mm or more, and the length L₀ can be set to 0.2 mm or more and 1.2 mm or less. To achieve high capacity, T₀ is preferably 1.5 times or more W₀, and more preferably 2.0 times or more. The shape of FIG. 13 may be applied to the first embodiment and the second embodiment.

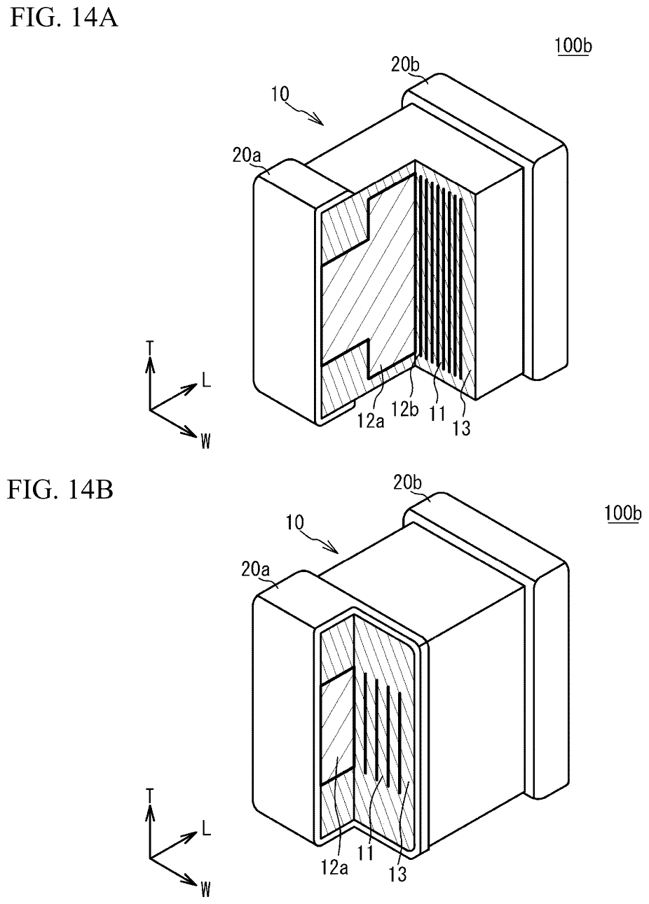

FIG. 14A and FIG. 14B are partial cross-sectional perspective views of the multilayer ceramic capacitor 100b according to the third embodiment. The multilayer ceramic capacitor 100b differs from the multilayer ceramic capacitor 100 according to the first embodiment in the stacking direction of the first internal electrode layers 12a and the second internal electrode layers 12b. In this embodiment, the W direction (second direction) corresponds to the stacking direction of the first internal electrode layers 12a and the second internal electrode layers 12b, and is the direction in which the upper face and the lower face of the multilayer chip 10 face each other. The T direction (first direction) is the direction in which the two side faces of the multilayer chip 10 face each other. The L direction (third direction) is the direction in which the two end faces of the multilayer chip 10 face each other.

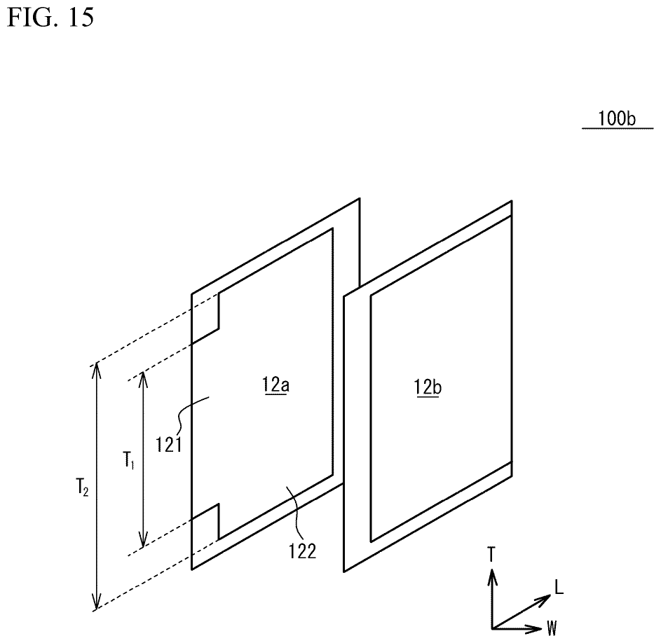

In this embodiment, the dimension of the first internal electrode layer 12a in the T direction is varied. As illustrated in FIG. 15, the first section 121 is connected to the first external electrode 20a in a section corresponding to the first end margin 15a and has a dimension T1 in the T direction. The second section 122 has a dimension T2 in the T direction in a section corresponding to the capacity section 14. The dimension T1 is smaller than the dimension T2. This configuration narrows the diffusion path of Cu when the first external electrode 20a is baked. This suppresses Cu diffusion even if the first internal electrode layer 12a contains a low-melting-point metal. This suppresses the occurrence of the cracks 40.

The first section 121 may have a shape that narrows in width as it approaches the first external electrode 20a. In this case, the dimension T1 refers to the width of the portion where the first section 121 is connected to the first external electrode 20a.

The T-direction dimension of the portion of the second internal electrode layer 12b that connects to the second external electrode 20b is larger than the T-direction dimension of the first section 121. For example, the T-direction dimension of the second internal electrode layer 12b is approximately constant at any point in the L direction. For example, the T-direction dimension of the portion of the second internal electrode layer 12b that connects to the second external electrode 20b is approximately equal to T2. This configuration ensures good contact between the second internal electrode layer 12b and the second external electrode 20b, ensuring the electrostatic capacity of the multilayer ceramic capacitor 100b.

For example, if T1/T2 is small, there is a risk of a decrease in capacity due to poor contact between the first external electrode 20a and the first internal electrode layer 12a. Therefore, it is preferable to set a lower limit for T1/T2. In this embodiment, if T2 is 100%, T1 is preferably 60% or more, and more preferably 70% or more. On the other hand, from the perspective of suppressing the cracks 40 due to expansion of the first internal electrode layer 12a, T1 is preferably 90% or less, and more preferably 80% or less.

Furthermore, from the perspective of suppressing the cracks 40 due to expansion of the first internal electrode layer 12a, the length in the L direction of the first section 121 is preferably ¼ or more, and more preferably ½ or more, of the L direction wraparound length (dimension e) of the first external electrode 20a. On the other hand, from the viewpoint of ensuring the intersection area between the first internal electrode layer 12a and the second internal electrode layer 12b, the length of the first section 121 in the L direction is preferably 1/1 or less, and more preferably ¾ or less, of the dimension e.

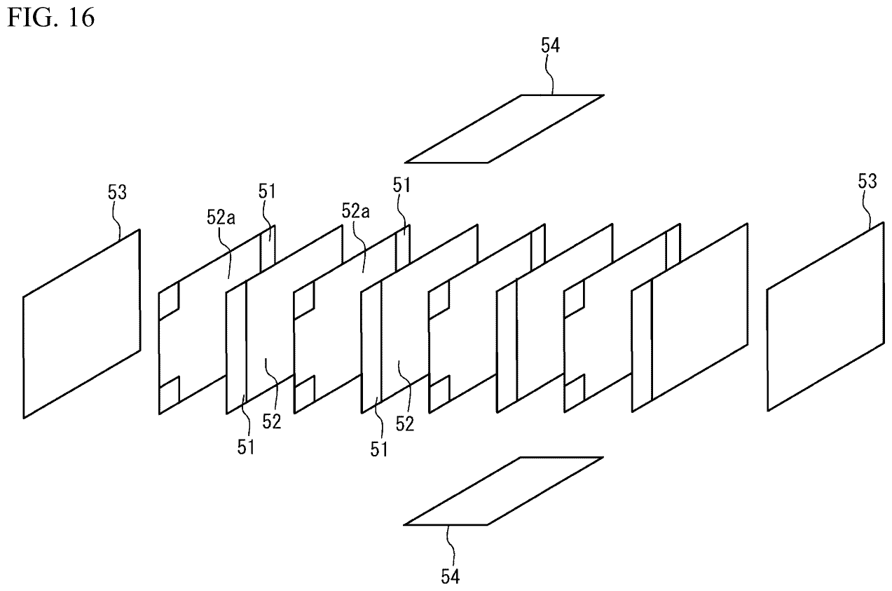

In the stacking process of FIG. 8, the multilayer ceramic capacitor 100b is produced by alternately stacking, in the W direction, first stack units each having the internal electrode pattern 52a formed on the dielectric green sheet 51 and second stack units each having the internal electrode pattern 52 formed on the dielectric green sheet 51, as illustrated in FIG. 16. The internal electrode pattern 52a corresponds to the shape of the first internal electrode layer 12a. The internal electrode pattern 52 corresponds to the shape of the second internal electrode layer 12b. Next, a predetermined number of the cover sheets 53 (for example, 2 to 10 layers) are stacked on both ends in the W direction of the multilayer body obtained by stacking the first stack units and the second stack units, and then thermocompression-bonded. The cover sheet 53 can be formed using the same method as the dielectric green sheet 51. Next, the multiple side margin sheets 54 are attached to both ends of the multilayer body in the T direction. The side margin sheets 54 can be formed using the same method as the dielectric green sheet 51.

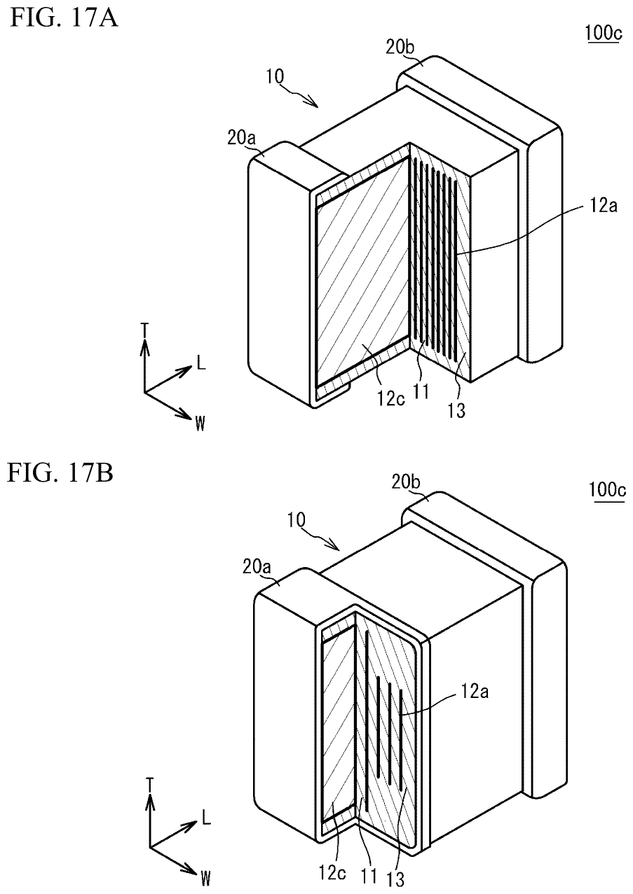

(Fourth Embodiment) FIG. 17A and FIG. 17B are partial cross-sectional perspective views of a multilayer ceramic capacitor 100c according to a fourth embodiment. The multilayer ceramic capacitor 100c differs from the multilayer ceramic capacitor 100a according to the second embodiment in the stacking direction of the first internal electrode layers 12a, the second internal electrode layers 12b, and the third internal electrode layers 12c. In this embodiment, the W direction (second direction) corresponds to the stacking direction of the first internal electrode layers 12a, the second internal electrode layers 12b, and the third internal electrode layers 12c, and is the direction in which the upper face and the lower face of the multilayer chip 10 face each other. The T direction (first direction) is the direction in which the two side faces of the multilayer chip 10 face each other. The L direction (third direction) is the direction in which the two end faces of the multilayer chip 10 face each other.

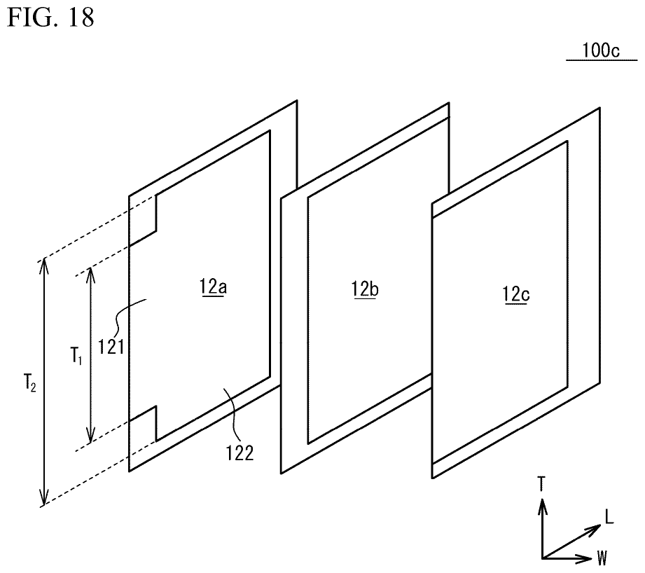

FIG. 18 is a diagram illustrating the shapes of the first internal electrode layer 12a, the second internal electrode layer 12b, and the third internal electrode layer 12c. As illustrated in FIG. 18, the width in the T direction of the portion of the third internal electrode layer 12c that connects to the first external electrode 20a is wider than the width in the T direction of the first section 121. For example, the width in the T direction of the third internal electrode layer 12c is approximately constant at any point in the L direction. This configuration ensures good contact between the third internal electrode layer 12c and the first external electrode 20a, ensuring the electrostatic capacity of the multilayer ceramic capacitor 100.

As illustrated in FIG. 17B, one or more of the third internal electrode layers 12c are provided in the center of the stacking direction without any of the first internal electrode layers 12a in between. The first internal electrode layers 12a are provided further outward in the W direction than the group of the third internal electrode layers 12c. With this configuration, the width of the internal electrode layers in the T direction is narrower in portions closer to the cover layer 13. This suppresses diffusion in corners where the cracks 40 are likely to occur, thereby suppressing the cracks 40. Meanwhile, good contact is achieved between the internal electrode layers and the first external electrode 20a near the center of the stacking direction. As a result, it is possible to both suppress the cracks 40 and ensure sufficient capacitance.

For example, if the number of the third internal electrode layers 12c is small, there is a risk that sufficient electrostatic capacity will not be secured. Therefore, it is preferable to set a lower limit on the number of the third internal electrode layers 12c. On the other hand, if the number of the third internal electrode layers 12c is too large, there is a risk that the occurrence of the cracks 40 is not suppressed. Therefore, it is preferable to set a lower and upper limit for the number of the third internal electrode layers 12c. In this embodiment, if the total number of internal electrode layers connected to the first external electrode 20a is 100%, the number of the third internal electrode layers 12c is preferably 5% to 40%.

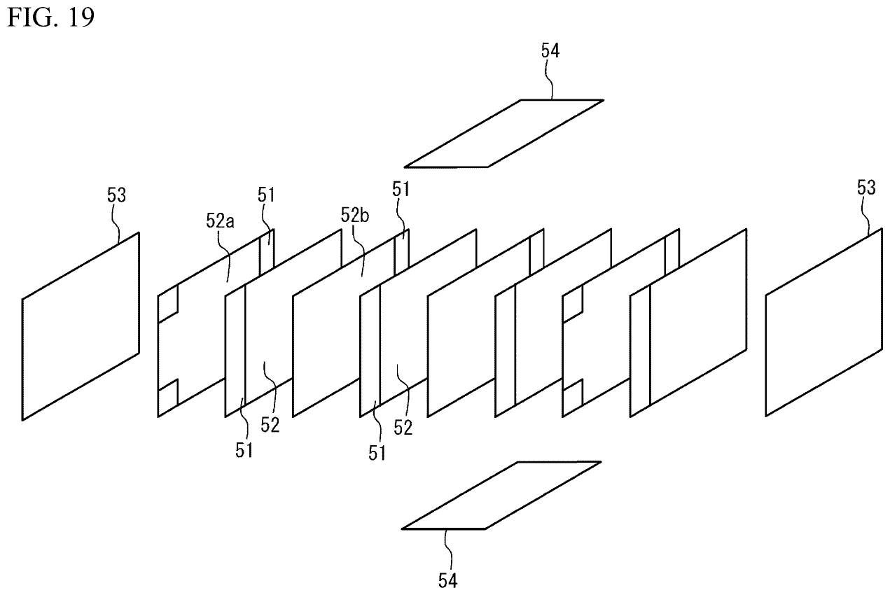

In the multilayer ceramic capacitor 100c of this embodiment, for example, as illustrated in FIG. 19, when stacking the stack units, a third stack unit in which the internal electrode pattern 52b having the same width as the dielectric green sheet 51 is formed on the dielectric green sheet 51 may be used in place of the first stack unit in which the internal electrode pattern 52a is formed on the dielectric green sheet 51 in the central portion of the stacking direction.

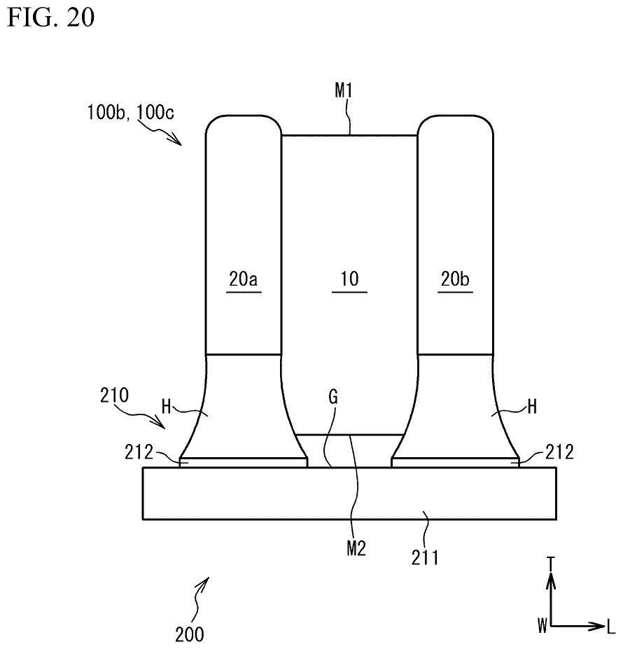

Now, the mounting of the multilayer ceramic capacitors 100b and 100c will be described. FIG. 20 is a side view of a circuit board 200 including the multilayer ceramic capacitors 100b and 100c. The circuit board 200 has a mounting substrate 210 on which the multilayer ceramic capacitors 100b and 100c are mounted. The mounting substrate 210 has a substrate 211 that extends along the planes of the L and W directions and has a mounting surface G that is orthogonal to the T direction, and a pair of connection electrodes 212 provided on the mounting surface G.

In the circuit board 200, the first external electrode 20a and the second external electrode 20b of the multilayer ceramic capacitors 100b and 100c are respectively connected to the pair of connection electrodes 212 on the mounting substrate 210 via solder H. As a result, in the circuit board 200, the multilayer ceramic capacitors 100b and 100c are fixed and electrically connected to the mounting substrate 210.

In the multilayer ceramic capacitors 100b, 100c, when the circuit board 200 is driven, if a voltage is applied to the first external electrode 20a and the second external electrode 20b via the connection electrodes 212 of the mounting substrate 210, electrostriction occurs in the multilayer chip 10 due to the piezoelectric effect. The electrostriction occurring in the multilayer chip 10 causes relatively large deformation in the stacking direction of the internal electrode layers.

In the circuit board 200, repeated electrostriction occurring in the multilayer ceramic capacitors 100b, 100c when an AC voltage is applied can cause vibrations in the thickness direction of the substrate 211 of the mounting substrate 210. In the circuit board 200, if the vibrations occurring in the substrate 211 become large, noise can be generated from the substrate 211, a phenomenon known as “acoustic noise.”

However, in the multilayer ceramic capacitors 100b and 100c according to this embodiment, the stacking direction of the internal electrode layers is the in-plane direction of the substrate 211, so vibrations in the thickness direction of the substrate 211 due to electrostriction of the multilayer chip 10 are unlikely to occur. Furthermore, in the multilayer ceramic capacitors 100b and 100c, the number of stacked internal electrode layers is small, and the amount of deformation due to electrostriction is kept small. Therefore, even if vibrations occur in the substrate 211, they are unlikely to be large enough to generate noise.

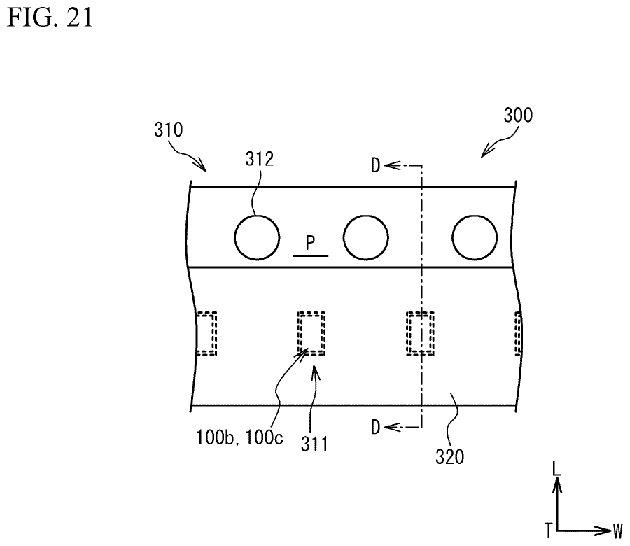

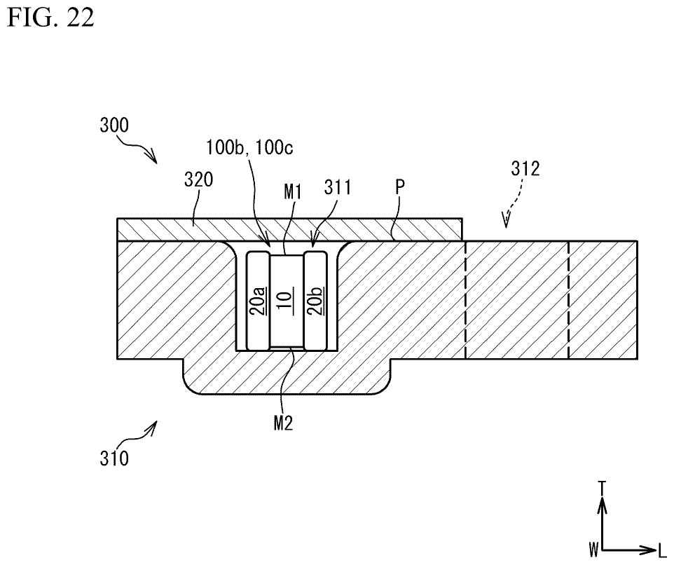

The multilayer ceramic capacitors 100b and 100c are prepared in a packaged state as a package 300 when mounted on the mounting substrate 210. FIG. 21 and FIG. 22 are diagrams illustrating the package 300. FIG. 21 is a partial plan view of the package 300. FIG. 22 is a cross-sectional view of the package 300 taken along a line D-D in FIG. 21.

The package 300 comprises the multilayer ceramic capacitors 100b and 100c, a carrier tape 310, and a top tape 320. The carrier tape 310 is configured as a long tape extending in the W direction. The carrier tape 310 has multiple recesses 311 arranged at intervals in the W direction, each of which can accommodate one of the multilayer ceramic capacitors 100b and 100c.

The carrier tape 310 has a sealing face P, which is an upward surface orthogonal to the T direction, and the multiple recesses 311 are recessed downward in the T direction from the sealing face P. In other words, the carrier tape 310 is configured so that the multilayer ceramic capacitors 100b, 100c inside the multiple recesses 311 can be removed from the sealing face P side.

The carrier tape 310 has multiple feed holes 312 that penetrate the carrier tape 310 in the T direction and are arranged at intervals in the W direction, at positions offset in the L direction from the row of the multiple recesses 311. The feed holes 312 are configured as engagement holes used by the tape feeding mechanism to feed the carrier tape 310 in the W direction.

In the package 300, the top tape 320 is attached to the sealing face P of the carrier tape 310 along the row of the multiple recesses 311, and the multiple recesses 311 containing the multiple multilayer ceramic capacitors 100b, 100c are collectively covered by the top tape 320. This allows the multiple multilayer ceramic capacitors 100b, 100c to be held in the multiple recesses 311.

As illustrated in FIG. 22, in the multilayer ceramic capacitors 100b, 100c in the multiple recesses 311 of the carrier tape 310, the first main surface M1 of the multilayer chip 10 facing upward in the T direction faces the top tape 320. The second main surface M2 of the multilayer chip 10 facing downward in the T direction faces the bottom of the multiple recesses 311.

When mounting the multilayer ceramic capacitors 100b, 100c packaged in the package 300, the top tape 320 is peeled off from the seal face P of the carrier tape 310 along the W direction. This allows the multiple recesses 311 in the package 300, each housing the multiple multilayer ceramic capacitors 100b, 100c, to be sequentially opened upward in the T direction.

The multilayer ceramic capacitors 100b, 100c housed in the opened recess 110 are removed with the first main surface M1 of the multilayer chip 10 facing upward in the T direction held by the tip of the suction nozzle of the mounting device. The mounting device moves the suction nozzle to move the multilayer ceramic capacitors 100b, 100c onto the mounting surface G of the mounting substrate 210.

The mounting device then positions the second main surface M2 of the multilayer chip 10 facing the mounting surface G, aligning the first external electrode 20a and the second external electrode 20b over the pair of connection electrodes 212 to which solder paste has been applied, and then releases the suction nozzle from holding the first main surface M1 of the multilayer chip 10. This places the multilayer ceramic capacitors 100b, 100c on the mounting surface G.

Then, using a reflow oven or the like, the solder paste is melted and then hardened on the mounting substrate 210, on which the multilayer ceramic capacitors 100b, 100c are placed on the mounting surface G. This connects the first external electrode 20a and the second external electrode 20b to the pair of connection electrodes 212 of the mounting substrate 210 via the solder H, thereby obtaining the circuit board 200 illustrated in FIG. 20.

Note that in each of the above embodiments, elements that form stable compounds with hydrogen reduce the effects of hydrogen generated during the plating process and suppress insulation degradation. Therefore, it is preferable that the second internal electrode layer 12b contain an element that forms a stable compound with hydrogen, other than a low-melting-point metal. Specifically, it is preferable that the second internal electrode layer 12b contain Ni as the main component, as well as Ag (silver), Au (gold), Ga (gallium), Ge (germanium), or the like.

Note that, although each of the above embodiments has been described with respect to a multilayer ceramic capacitor as an example of a ceramic electronic component, this is not limiting. For example, the configuration of each of the above embodiments can also be applied to other multilayer ceramic electronic components, such as varistors and thermistors.

### Examples

The multilayer ceramic capacitors according to the following embodiments were fabricated and their characteristics were investigated.

(Example 1) In Example 1, the multilayer ceramic capacitor described in the first embodiment was produced. First, a slurry mainly composed of BaTiO₃ was mixed and coated to obtain a dielectric green sheet. An internal electrode pattern was printed on each dielectric green sheet to obtain a stack unit. Nickel powder was used for the internal electrode pattern. In the first stack unit, the width of the end of the internal electrode pattern was made smaller than the width of the dielectric green sheet. In addition, in the first stack unit, 1.0 at % Sn was added when Ni was 100 at % in the internal electrode pattern. 250 layers of the obtained stack unit were stacked to obtain a stack. In the second stack unit, Sn was not added to the internal electrode pattern.

Multiple cover sheets were stacked and pressed on the top and bottom of the stack in the stacking direction, and then a binder removal process was performed. Then, the stack was fired and re-oxidized. A metal paste mainly composed of Cu was applied to two end faces of the obtained multilayer chip, and baked at around 800° C. Through these processes, a multilayer ceramic capacitor was produced in a 0603 shape (length L: 600 μm, width W: 300 μm, height T: 300 μm) in which 250 internal electrode layers were stacked.

In the fired multilayer ceramic capacitor, the first internal electrode layer 12a and the second internal electrode layer 12b had a thickness of 0.5 μm, and each of the dielectric layers 11 had a thickness of 0.5 μm. The thickness of each cover layer in the T direction was 25 μm. The thickness of each side margin in the W direction was 25 μm. The width W₂ in the W direction of each internal electrode layer was 250 μm. The width W₁ of the first section of the first internal electrode layer 12a was 200 μm. The length in the L direction of the first section 121 of the first internal electrode layer 12a was 50 μm. The dimension e of the first external electrode 20a was 150 μm.

(Example 2) In Example 2, the multilayer ceramic capacitor described in the second embodiment was produced. In Example 2, of the internal electrode layers connected to the first external electrode 20a, the central 75 layers were the third internal electrode layers 12c, and the top and bottom 25 layers were the first internal electrode layers 12a. The thickness of the third internal electrode layer 12c was 0.5 μm. The width W₂ of the third internal electrode layer 12c in the W direction was 250 μm. The other conditions were the same as in Example 1.

(Comparative Example 1) In Comparative Example 1, instead of the 125 layers of the first internal electrode layers 12a, an internal electrode layer whose width in the W direction was constant at any point in the L direction was used. Other conditions were the same as in Example 1.

(Crack Generation) 100 samples were prepared for each of Examples 1 and 2 and Comparative Example 1, and the WT cross section of the portion where the first external electrode 20a was provided was observed. No cracks were found in either Example 1 or 2. This is believed to be because the width of the end of the first internal electrode layer 12a on the first external electrode 20a side was narrowed, which suppressed the expansion of the first internal electrode layer 12a due to the diffusion of Cu from the first external electrode 20a. In contrast, cracks were found in at least one of the four corners in Comparative Example 1. This is believed to be because the width of the internal electrode layer connected to the first external electrode 20a was not narrow.

(Electrostatic capacity) Next, the electrostatic capacity was measured for each of 100 samples for Examples 1 and 2 under the conditions of 1 kHz and 0.5 Vrms. The average electrostatic capacity was calculated. The electrostatic capacity was 1.89 μF in Example 1, and 2.03 μF in Example 2. Thus, sufficient electrostatic capacity was obtained in both Examples 1 and 2. This is believed to be because the width of the second internal electrode layer 12b connected to the second external electrode 20b was wide.

In addition, the average value of the sample of Example 2 was 5% or more higher than that of the sample of Example 1. This is believed to be because the width of the drawn-out portion of the internal electrode at the center in the height direction in the sample of Example 2 was not narrowed, so that the connection with the external electrode was sufficiently secured and the decrease in electrostatic capacity due to poor contact (so-called capacitance decrease) was suppressed. Note that in Comparative Example 1, poor insulation occurred due to the occurrence of cracks, and the electrostatic capacity could not be measured.

The results of Examples 1 and 2 and Comparative Example 1 are shown in Table 1.

TABLE 1

| | | | | | LENGTH | | | | | | ELECTRO- |
|---|---|---|---|---|---|---|---|---|---|---|---|
| | | ADDED | | | OF DRAWN | STACKED NUMBER OF | | | SIZE | | STATIC |
| | ADDED | AMOUNT | W1 | W2 | PORTION | INTERNAL ELECTRODE | | | e | | CAPACITY |
| | METAL | (at %) | (μm) | (μm) | (μm) | FIRST | SECOND | THIRD | (μm) | CRACK | (μF) |
| EXAMPLE 1 | Sn | 1.0 | 200 | 250 | 50 | 125 | 125 | — | 150 | ABSENT | 1.89 |
| EXAMPLE 2 | Sn | 1.0 | 200 | 250 | 50 | EACH | 125 | 75 | 150 | ABSENT | 2.03 |
| | | | | | | 25 | | | | | |
| COMPARATIVE | Sn | 1.0 | — | 250 | — | TOTAL 250 | | | 150 | PRESENT | — |
| EXAMPLE 1 | | | | | | | | | | | |

(Example 3) In Example 3, the multilayer ceramic capacitor described in the first embodiment was fabricated. First, a BaTiO₃-based slurry was formulated and applied to obtain dielectric green sheets. Internal electrode patterns were printed on each dielectric green sheet to obtain stack units. Nickel powder was used for the internal electrode patterns. In the first stack unit, the width of the internal electrode pattern edge was made smaller than the width of the dielectric green sheet. Furthermore, in the first stack unit, 1.0 at % Sn was added to the internal electrode pattern when Ni was 100 at %. 350 layers of the resulting stack units were stacked to obtain a multilayer body. In the second stack unit, no Sn was added to the internal electrode pattern.

Multiple cover sheets were stacked and pressed on the top and bottom of the above-mentioned multilayer body in the stacking direction, followed by a binder removal process. The multilayer body was then fired and re-oxidized. A metal paste primarily composed of Cu was applied to two end faces of the resulting multilayer chip and baked at approximately 800° C. Through these processes, a multilayer ceramic capacitor was fabricated with a length L of 600 μm, a width W of 300 μm, and a height T of 400 μm, and 350 stacked internal electrode layers.

In the fired multilayer ceramic capacitor, the first internal electrode layer 12a and the second internal electrode layer 12b had a thickness of 0.5 μm, and each of the dielectric layers 11 had a thickness of 0.5 μm. The thickness of each of the cover layer in the T direction was 25 μm. The thickness of each of the side margins in the W direction was 25 μm. The width W₂ of each of the internal electrode layers in the W direction was 250 μm. The width W₁ of the first section 121 of the first internal electrode layer 12a was 200 μm. The length in the L direction of the first section 121 of the first internal electrode layer 12a was 50 μm. The dimension e of the first external electrode 20a was 150 μm. The number of the stacked first internal electrode layers 12a was 175, and the number of the stacked second internal electrode layers 12b was 175.

(Example 4) In Example 4, the multilayer ceramic capacitor described in the second embodiment was fabricated. In Example 2, of the internal electrode layers connected to the first external electrode 20a, the central 95 layers in the stacking direction were designated as the third internal electrode layers 12c, and the top and bottom 40 layers were designated as the first internal electrode layers 12a. The thickness of the third internal electrode layer 12c was 0.5 μm. The width W₂ of the third internal electrode layer 12c in the W direction was 250 μm. Other conditions were the same as in Example 3.

(Comparative Example 2) In Comparative Example 2, instead of the 175 first internal electrode layers 12a, internal electrode layers with a constant width in the W direction were used at all points in the L direction. Other conditions were the same as in Example 3.

(Example 5) In Example 5, a multilayer ceramic capacitor similar to that described in the first embodiment was fabricated. In Example 5, a multilayer ceramic capacitor with a length L of 600 μm, a width W of 300 μm, and a height T of 500 μm was fabricated, with 450 internal electrode layers stacked.

In the fired multilayer ceramic capacitor, the thicknesses of the first internal electrode layers 12a and the second internal electrode layers 12b were 0.5 μm, and the thickness of each of the dielectric layers 11 was 0.5 μm. The thickness of each of the cover layers in the T direction was 25 μm. The thickness of each of the side margins in the W direction was 25 μm. The width W₂ of each of the internal electrode layers in the W direction was 250 μm. The width W₁ of the first section 121 of the first internal electrode layer 12a was 200 μm. The length of the first section 121 of the first internal electrode layer 12a in the L direction was 50 μm. The dimension e of the first external electrode 20a was 150 μm. The number of layers of the first internal electrode layers 12a was 225, and the number of layers of the second internal electrode layers 12b was 225. Other conditions were the same as in Example 3.

(Example 6) In Example 6, the multilayer ceramic capacitor described in the second embodiment was fabricated. In Example 6, of the internal electrode layers connected to the first external electrode 20a, the central 125 layers in the stacking direction were designated as the third internal electrode layers 12c, and the remaining 50 layers above and below were designated as the first internal electrode layers 12a. The thickness of the third internal electrode layer 12c was 0.5 μm. The width W₂ of the third internal electrode layer 12c in the W direction was 250 μm. All other conditions were the same as in Example 5.

(Comparative Example 3) In Comparative Example 3, instead of the 225 first internal electrode layers 12a, internal electrode layers whose width in the W direction was constant throughout the L direction were used. All other conditions were the same as in Example 5.

(Example 7) In Example 7, a multilayer ceramic capacitor similar to that described in the third embodiment was fabricated. In Example 7, a multilayer ceramic capacitor was fabricated with a length L of 600 μm, a width W of 300 μm, and a height T of 500 μm, and 250 stacked internal electrode layers.

In the fired multilayer ceramic capacitor, the first internal electrode layer 12a and the second internal electrode layer 12b had a thickness of 0.5 μm, and each of the dielectric layers 11 had a thickness of 0.5 μm. The thickness of each of the cover layers in the W direction was 25 μm. The thickness of each of the side margins in the T direction was 25 μm. The width T2 of each of the internal electrode layers in the T direction was 450 μm. The width Tl of the first section 121 of the first internal electrode layer 12a was 350 μm. The length of the first section 121 of the first internal electrode layer 12a in the L direction was 50 μm. The dimension e of the first external electrode 20a was 150 μm. The number of the stacked first internal electrode layers 12a was 125, and the number of the stacked second internal electrode layers 12b was 125. Other conditions were the same as in Example 3.

(Example 8) In Example 8, the multilayer ceramic capacitor described in the fourth embodiment was fabricated. In Example 8, of the internal electrode layers connected to the first external electrode 20a, the central 65 layers in the stacking direction were designated as the third internal electrode layers 12c, and 30 layers on either side of a group of the third internal electrode layers 12c were designated as the first internal electrode layers 12a. The thickness of the third internal electrode layers 12c was 0.5 μm. The width T2 in the T direction of the third internal electrode layers 12c was 450 μm. Other conditions were the same as in Example 7.

(Comparative Example 4) In Comparative Example 4, instead of the 125 first internal electrode layers 12a, internal electrode layers with a constant width in the T direction at any point in the L direction were used. All other conditions were the same as in Example 7.

The results of the conditions for Examples 3-7 and Comparative Examples 2-4 are shown in Tables 2 and 3.

TABLE 2

| | | | | | | LENGTH | | | | |
|---|---|---|---|---|---|---|---|---|---|---|
| | SIZE | | | | | OF DRAWN | STACKED NUMBER OF | | | SIZE |
| | (μm) | | | W1 | W2 | PORTION | INTERNAL ELECTRODE | | | e |
| | L | W | T | (μm) | (μm) | (μm) | FIRST | SECOND | THIRD | (μm) |
| EXAMPLE 3 | 600 | 300 | 400 | 200 | 250 | 50 | 175 | 175 | — | 150 |
| EXAMPLE 4 | | | | 200 | 250 | 50 | EACH | 175 | 95 | 150 |
| | | | | | | | 40 | | | |
| COMPARATIVE | | | | — | 250 | — | [symbol] 350 | | | 150 |
| EXAMPLE 2 | | | | | | | | | | |
| EXAMPLE 5 | 600 | 300 | 500 | 200 | 250 | 50 | 225 | 225 | — | 150 |
| EXAMPLE 6 | | | | 200 | 250 | 50 | EACH | 225 | 125 | 150 |
| | | | | | | | 50 | | | |
| COMPARATIVE | | | | — | 250 | — | TOTAL 450 | | | 150 |
| EXAMPLE 3 | | | | | | | | | | |

TABLE 3

| | | | | | | LENGTH | | | | |
|---|---|---|---|---|---|---|---|---|---|---|
| | SIZE | | | | | OF DRAWN | STACKED NUMBER OF | | | SIZE |
| | (μm) | | | T1 | T2 | PORTION | INTERNAL ELECTRODE | | | e |
| | L | W | T | (μm) | (μm) | (μm) | FIRST | SECOND | THIRD | (μm) |
| EXAMPLE 7 | 600 | 300 | 500 | 350 | 450 | 50 | 125 | 125 | — | 150 |
| EXAMPLE 8 | | | | 350 | 450 | 50 | EACH | 125 | 65 | 150 |
| | | | | | | | 30 | | | |
| COMPARATIVE | | | | — | 450 | — | TOTAL 250 | | | 150 |
| EXAMPLE 4 | | | | | | | | | | |

(Crack Occurrence) One hundred samples were fabricated for each of Examples 3-8 and Comparative Examples 2-4, and the WT cross sections where the first external electrode 20a was located were observed. No cracks were observed in any of Examples 3-8. This is believed to be because the narrow end of the first internal electrode layer 12a on the first external electrode 20a side prevented expansion of the first internal electrode layer 12a due to Cu diffusion from the first external electrode 20a. In contrast, cracks were observed in at least one of the four corners in Comparative Examples 2-4. This is believed to be because the width of the internal electrode layer connected to the first external electrode 20a was not narrow.

(Electrostatic Capacity) Next, the electrostatic capacity of 100 samples for each of Examples 3-8 was measured at 1 kHz and 0.5 Vrms. The average electrostatic capacity was calculated. The electrostatic capacity was 2.45 μF in Example 3, 2.63 μF in Example 4, 2.84 μF in Example 5, 2.97 μF in Example 6, 2.92 μF in Example 7, and 3.01 μF in Example 8. Thus, sufficient electrostatic capacity was obtained in all of Examples 3 to 8. This is believed to be due to the wide width of the second internal electrode layer 12b connected to the second external electrode 20b.

Furthermore, the average value of the samples of Examples 4 and 6 was 5% or more higher than that of the samples of Examples 3 and 5. This is believed to be because the width of the internal electrode extension portion at the center in the height direction in the samples of Examples 4 and 6 was not narrowed, ensuring sufficient connection with the external electrode and suppressing capacitance decrease due to poor contact (so-called capacitance decrease). Note that in Comparative Examples 2 to 4, electrostatic capacity measurement was impossible due to poor insulation caused by cracks.

(Sound volume) For Examples 5-8, 100 samples each were mounted on a circuit board and their sound volume was measured. Specifically, an AC voltage of 5V was applied to each sample while increasing the frequency from 0 to 1 MHz. The intensity (in dB) of the audible sound generated was measured individually in a soundproof, anechoic chamber (manufactured by Yokohama Sound Environment Systems) using a Brüel & Kjær Japan TYPe-3560-B130.

For Examples 5 and 6, all samples were confirmed to exceed the acceptable level of 25 dB for acoustic noise. On the other hand, for Examples 7 and 8, all samples were confirmed to have sound volume levels below 25 dB. This is thought to be due to the fact that, compared to the structure of Examples 5 and 6, Examples 7 and 8 have a smaller number of layers, resulting in smaller electrostrictive vibrations, and that the layers are stacked in a direction that makes it difficult for electrostrictive vibrations to be transmitted to the circuit board. Note that for Comparative Examples 2 to 4, cracks occurred and poor insulation prevented sound volume measurements.

The results for crack occurrence, electrostatic capacity, and sound volume are shown in Table 4.

TABLE 4

| | | ELECTROSTATIC | SOUND |
|---|---|---|---|
| | | CAPACITY | VOLUME |
| | CRACK | (μF) | (dB) |
| EXAMPLE 3 | ABSENT | 2.45 | |
| EXAMPLE 4 | ABSENT | 2.63 | |
| COMPARATIVE | PRESENT | — | |
| EXAMPLE 2 | | | |
| EXAMPLE 5 | ABSENT | 2.84 | 25 OR MORE |
| EXAMPLE 6 | ABSENT | 2.97 | 25 OR MORE |
| COMPARATIVE | PRESENT | — | — |
| EXAMPLE 3 | | | |
| EXAMPLE 7 | ABSENT | 2.92 | LESS THAN 25 |
| EXAMPLE 8 | ABSENT | 3.01 | LESS THAN 25 |
| COMPARATIVE | PRESENT | — | — |
| EXAMPLE 4 | | | |

Although the embodiments of the present invention have been described in detail, it is to be understood that the various change, substitutions, and alterations could be made hereto without departing from the spirit and scope of the invention.

What is claimed is:

1. A ceramic electronic component comprising:
a multilayer chip in which a first internal electrode layer mainly made of Ni and a second internal electrode layer mainly made of Ni are alternately stacked with a dielectric layer sandwiched therebetween, has a substantially rectangular parallelepiped shape, and is formed so that the first internal electrode layer and the second internal electrode layer are alternately drawn out to first and second end faces opposing each other of the substantially rectangular parallelepiped shape;
a first external electrode provided on the first end face, the first external electrode having a contact layer in contact with the first end face, the contact layer being mainly composed of Cu; and
a second external electrode provided on the second end face, the second external electrode having a contact layer that is in contact with the second end face and that is mainly composed of Cu,
wherein at least the first internal electrode layer of the first internal electrode layer and the second internal electrode layer contains a low melting point metal having a melting point lower than a melting point of Pb,
wherein a concentration of the low melting point metal is higher in the first internal electrode layer than in the second internal electrode layer,
wherein a width of a portion of the first internal electrode layer that connects to the first external electrode in a direction orthogonal to a stacking direction is narrower than a width of a portion facing the second internal electrode layer, and
wherein a width of a portion of the second internal electrode layer that connects to the second external electrode in a direction orthogonal to the stacking direction is wider than a width of a portion of the first internal electrode layer that connects to the first external electrode.

2. The ceramic electronic component as claimed in claim 1, wherein the low melting point metal is Sn.

3. The ceramic electronic component as claimed in claim 1, wherein the second internal electrode layer includes a metal element that forms a stable compound with hydrogen, except for the low melting point metal.

4. The ceramic electronic component as claimed in claim 3, wherein the metal element that forms the stable compound with hydrogen is at least one of Ag, Au, Ga, or Ge.

5. The ceramic electronic component as claimed in claim 1, wherein the width of the portion of the second internal electrode layer that is connected to the second external electrode in a direction orthogonal to the stacking direction is same as a width of a portion of the second internal electrode layer that faces the first internal electrode layer.

6. The ceramic electronic component as claimed in claim 1, wherein the width of the portion of the first internal electrode layer that is connected to the first external electrode in the direction orthogonal to the stacking direction is 60% to 90% of the width of the portion that faces the second internal electrode layer.

7. The ceramic electronic component as claimed in claim 1, wherein a third internal electrode layer that connects to the first external electrode is provided in center of the stacking direction, and
wherein a width of a portion of the third internal electrode layer that connects to the first external electrode in the direction orthogonal to the stacking direction is same as a width of the portion that faces the second internal electrode layer.

8. The ceramic electronic component as claimed in claim 7, wherein a number of the third internal electrode layer is 5% to 40% of a number of internal electrode layers connected to the first external electrode.

9. The ceramic electronic component as claimed in claim 1, wherein in a direction in which the first end face and the second end face face each other, a length of the portion of the first internal electrode layer that is connected to the first external electrode and is narrower than the width of the portion that faces the second internal electrode layer is ¼ or more and 1/1 or less of a length of the first external electrode.

10. The ceramic electronic component as claimed in claim 1,
wherein a first direction, a second direction and a third direction are orthogonal to each other,
wherein a dimension of the ceramic electronic component in the first direction is 1.3 times or more a dimension of the ceramic electronic component in the second direction, and
wherein the first and second end faces opposes in the third direction.

11. A manufacturing method of a ceramic electronic component comprising:
preparing a multilayer chip in which a first internal electrode layer mainly made of Ni and a second internal electrode layer mainly made of Ni are alternately stacked with a dielectric layer sandwiched therebetween, has a substantially rectangular parallelepiped shape, and is formed so that the first internal electrode layer and the second internal electrode layer are alternately drawn out to first and second end faces opposing each other of the substantially rectangular parallelepiped shape, wherein at least the first internal electrode layer of the first internal electrode layer and the second internal electrode layer contains a low melting point metal having a melting point lower than a melting point of Pb, wherein a concentration of the low melting point metal is higher in the first internal electrode layer than in the second internal electrode layer, wherein a width of a portion of the first internal electrode layer drawn to the first end face in a direction orthogonal to a stacking direction is narrower than a width of a portion facing the second internal electrode layer, and wherein a width of a portion of the second internal electrode layer drawn to the second end face in a direction orthogonal to the stacking direction is wider than a width of a portion of the first internal electrode layer drawn to the first end face; and
baking an external electrode on each of the first end face and the second end face, a main component of the external electrode being Cu.
